(19) United States
(12) Patent Application Publication
(10) Pub. No.: US 2006/0230169 A1
(43) Pub. Date: Oct. 12, 2006

(54) System and method to simultaneously transcode audio and video content for optimized streaming via mobile telecommunications

(76) Inventors: Mark Mitchell Kaplan, Chicago, IL (US); Colin Ran, Brooklyn, NY (US)

Correspondence Address: KATTEN MUCHIN ROSENMAN LLP, 575 MADISON AVENUE, NEW YORK, NY, 10022-2585, US

(21) Appl. No.: 11/081,719

(22) Filed: Mar. 17, 2005

Related U.S. Application Data
(60) Provisional application No. 60/627,983, filed on Nov. 15, 2004.

(51) Int. Cl. G06F 15/16

(52) U.S. Cl. 709/231

(57) ABSTRACT

A method to simultaneously transcode audio and video content for optimized streaming over one or more mobile telecommunications networks, wherein a streaming server receives multimedia content, transcodes the received multimedia content, and forwards the transcoded multimedia content to a telecommunications hub, wherein the telecommunication hub streams the forwarded multimedia content along with a media player to a mobile device over a mobile telecommunications network. The media player (that is transferred onto the mobile device) is used to render the streamed multimedia content in said at least one mobile device (e.g., a Java-enabled telephone). In one example, the transcoded data is encrypted prior to being streamed to the mobile device, and the transferred media player is used to decrypt and render multimedia data on a mobile device. Based on the disclosed method, broadcast content can be received by any multimedia enabled mobile telephone (e.g., Java-enabled phone) and the user is not required to purchase any additional equipment for receiving satellite broadcasts as the method utilizes the existing telecommunications infrastructure.

### BACKGROUND OF THE INVENTION

1. Field of Invention

The present invention relates generally to the field of broadcasting. More specifically, the present invention is related to transcoding audio and video content for optimized streaming via mobile telecommunications.

2. Discussion of Prior Art

FIG. 1 discloses a prior art setup wherein mobile users use their cellular telephones 102, 104, and 106 to request and receive content from various content providers 108, 110, and 112 over a wireless network 114. Content providers 108, 110, and 112 serve a myriad of data content such as news, email, etc. Formatting servers 116, 118, and 120, associated with content providers 108, 110, and 112, convert requested data into an appropriate format (i.e., format appropriate for being transferred over a wireless network and appropriate for being rendered in a cellular telephone) prior to being pushed to cellular telephones 102, 104, and 106. Formatting servers 116, 118, and 120 communicate with appropriate content provider server 108, 110, 112 over networks 120, 122, 124, wherein networks 120, 122, or 124 are any of the following: local area network (LAN), wide area network (WAN), or the Internet.

In a specific example illustrating data transfer in the setup of FIG. 1, cellular telephone users with Internet connectivity send a request to read their email over wireless network 114 to the appropriate service provider offering wireless access to email. Then, the service provider (108, 110, or 112) establishes a communication link with the requesting cellular telephone and converts data (in this case, email data) in the content server in a format appropriate for being transferred over a wireless network and appropriate for being rendered in the requesting cellular telephone.

The patent publication to Patsiokas et al. (2004/0266336) appears to teach a satellite radio receiver device 100 used in receiving and manipulating satellite broadcast content. In the '336 publication, Patsiokas et al. teach that receiver device 100 is able to connect to a cellular phone through a cable, a Bluetooth wireless connection, or otherwise. Additionally, Patsiokas et al. also appear to disclose that the receiver device can be integrated in a cellular telephone. According to the method/system of Patsiokas et al., it appears that a user would have to purchase either a cellular telephone that has such a satellite receiver integrated within or purchase a satellite receiver with a Bluetooth wireless interface or cable interface. However, the Patsiokas et al. reference fails to teach formatting broadcast content or a telecommunication hub streaming such formatted broadcast content to mobile telephones. Furthermore, the Patsiokas et al. reference also fails to teach the transmission of a media player along with the streamed content.

Whatever the precise merits, features, and advantages of the above cited references, none of them achieves or fulfills the purposes of the present invention.

### SUMMARY OF THE INVENTION

The present invention provides for a method of utilizing existing hardware with novel software to provide the end-user with optimized media. A transcoding server transcodes and optimizes the media (by reducing the bit rate and translating the stream into different codecs) to be streamed for various mobile telecommunications networks' bandwidth requirements. In one embodiment, the transcoding server is installed into a telecommunications hub where it processes end-user access requests and deliver appropriate media.

The present invention provides for a method for simultaneously transcoding audio and video content for optimized streaming over one or more mobile telecommunications networks, wherein the method comprises the steps of: (a) receiving multimedia content; (b) transcoding the received multimedia content; and (c) forwarding the transcoded multimedia content to a hub, wherein the hub streams the forwarded multimedia content along with a media player to at least one mobile device over a mobile telecommunications network. In this embodiment, the media player is used to render the streamed multimedia content in at least one mobile device.

The present invention also provides for a method for simultaneously transcoding audio and video content for optimized streaming over one or more mobile telecommunications networks, wherein the method comprises the steps of: (a) receiving multimedia content; (b) transcoding the received multimedia content; (c) encrypting the trancoded multimedia content; and (c) forwarding the encrypted multimedia content to a hub, wherein the hub streams the forwarded multimedia content along with a media player to at least one mobile device over a mobile telecommunications network. In this embodiment, the media player is used to decrypt and render the encrypted multimedia content in at least one mobile device.

In one embodiment, the present invention's method and system transcodes and streams multimedia data along with a Java-based application, which enables ubiquitous compatibility and live streaming over mobile networks.

### BRIEF DESCRIPTION OF THE DRAWINGS

FIG. 1 illustrates a prior art communications setup.

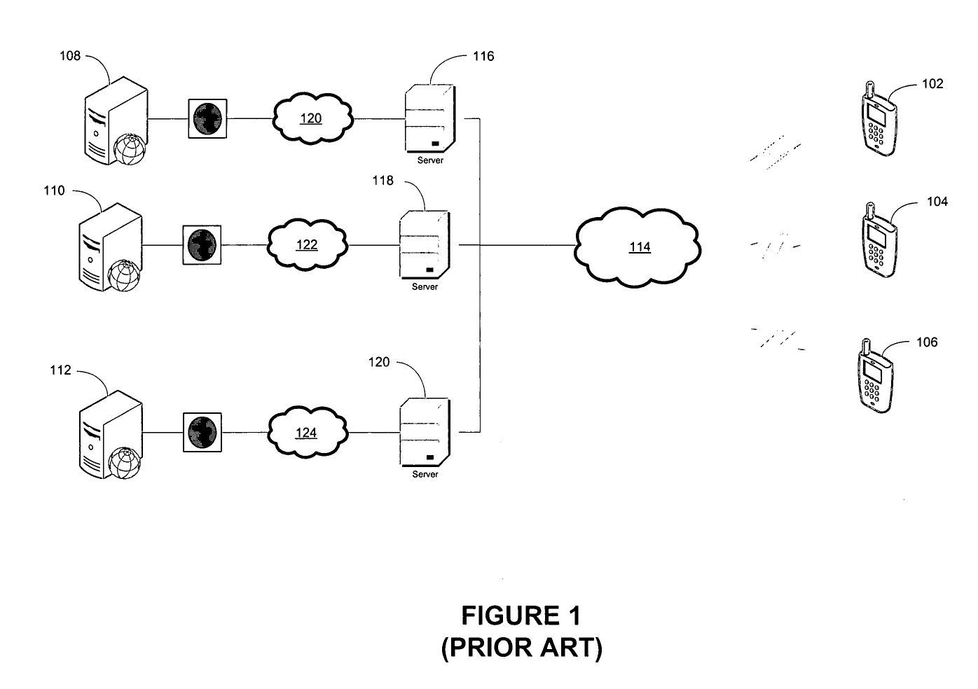

FIG. 2 illustrates an overview of the preferred embodiment of the present invention system to stream live audio and video to at least one mobile device over a telecommunications network.

FIG. 3 illustrates one embodiment of the present invention's method to simultaneously transcode audio and video content for optimized streaming over one or more mobile telecommunications networks.

FIG. 4 illustrates the encryption embodiment of the present invention's method to simultaneously transcode audio and video content for optimized streaming over one or more mobile telecommunications networks.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

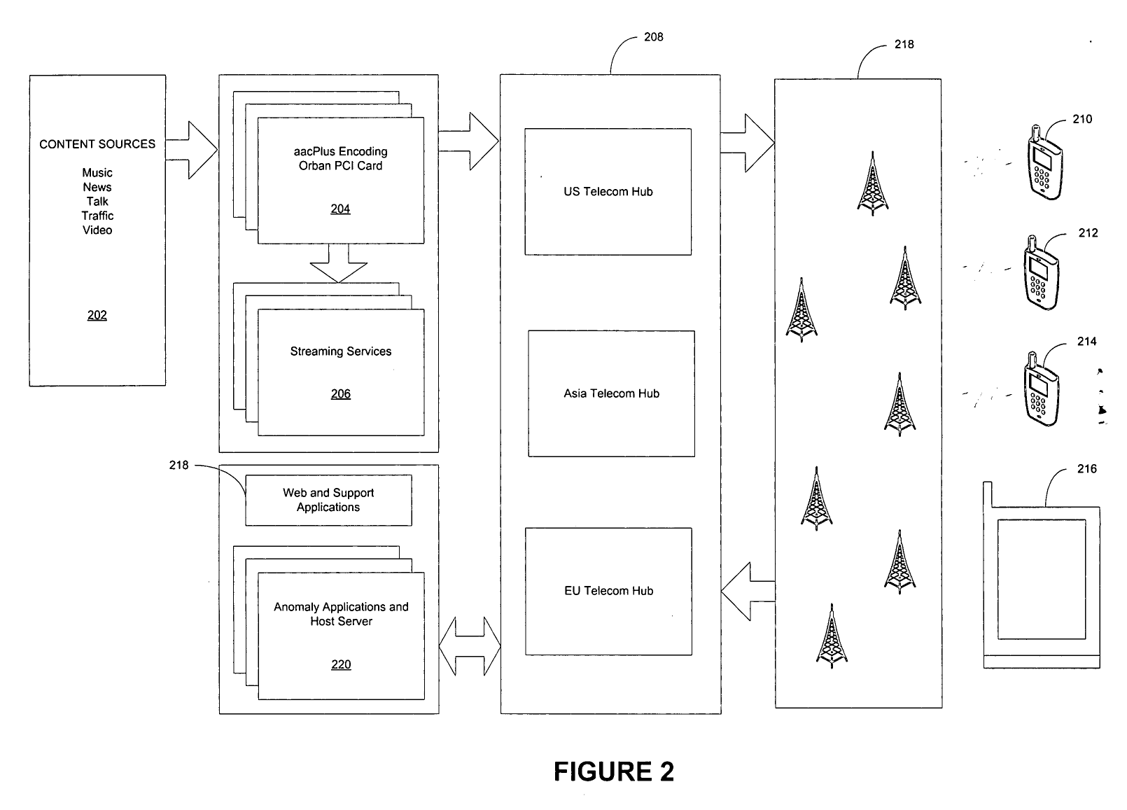

FIG. 2 illustrates an overview of the preferred embodiment of the present invention system to stream live audio and video to at least one mobile device over a telecommunications network. The system of FIG. 2 comprises content sources 202, transcoder 204, streamer 206, telecommunications hub 208, one or more mobile devices 210, 212, 214, and 216 accessible over at least one mobile telecommunications network 218, and support application systems.

Content Source 202 comprises multimedia data (e.g., audio or video data) from a content provider. The multimedia data (e.g., music, news, talk, traffic, video data) is either real-time data or pre-stored multimedia audio/video files. Such data channels (from content providers) are in raw format and are aggregated from a variety of internal and 3^{rd} party content.

Transcoder 204 processes raw audio/video from content source 202 and reduces the bit rate streams for streaming over carrier networks. Transcoding is content-specific and end result bit rates will vary between 56 kps to 16 kps. In one embodiment, spectral band replication (SBR) and perceptual audio coders are used. For example, by using both SBR and perceptual encoding techniques developed by Coding Technologies™ aacPlus (e.g., MPEG4 aacPlus that is a combination of three MPEG technologies comprising Advanced Audio Coding, SBR, and parametric stereo(PS) technologies), the quality of the recording is enhanced, thereby providing the end-user with a rewarding experience. Presently, such perceptual audio coders are used in Internet streaming. The present invention's streaming system used along with such perceptual audio coders enable optimization of multimedia data for mobile telecommunications streaming.

Each transcoded stream is published over IP by using standard streaming servers 206. In the preferred embodiment, streaming servers 206 are located in close proximity to the carrier network to reduce system latency.

Content to be routed to mobile carrier networks use telecommunications hub 208. Hub 208 is a combination of internal resources, partners and 3^{rd} party systems. This arrangement provides access to 90% of the world's mobile carriers, enabling the broad adoption of a multimedia experience.

In the preferred embodiment, the media player application is built using the latest a cross-platform technology such as java based technologies to support cross platform compatibility. The custom experience gives the consumer a whole media experience, including interactive content.

Additional applications are built and hosted (such as Web and support applications 218 and Anomaly applications and host server 220) to support both the consumer experience and operational business processes such as billing and consumer account management. The consumer experience applications include supplemental content aggregation and publishing such as streaming video, pictures and related textual descriptions, subscriber authentication and content rights management, personalization and management of subscription service. Such additional consumer experience components can be accessed either through a web interface or via an interface on a mobile device, be it a native application, java application or mobile web application.

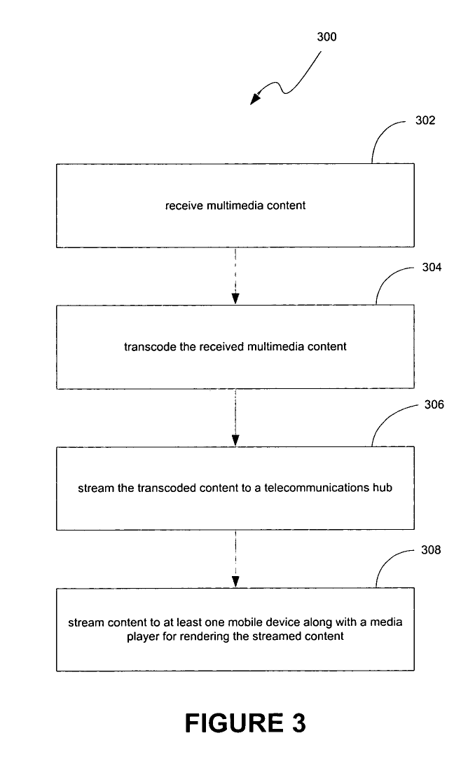

FIG. 3 illustrates one embodiment of the present invention's method 300 to simultaneously transcode audio and video content for optimized streaming over one or more mobile telecommunications networks. In step 302, multimedia content (e.g., music, video, news, talk, traffic, etc.) is received by a transcoding server and, in step 304, the transcoding server transcodes the received multimedia content. Next, in step 306, the transcoding server forwards the transcoded multimedia content to a telecommunications hub, wherein the telecommunications hub, in step 308, streams the forwarded multimedia content along with a media player to at least one mobile device over a mobile telecommunications network. In this embodiment, the media player that is sent along with the multimedia data is used to render the streamed multimedia content in at least one mobile device.

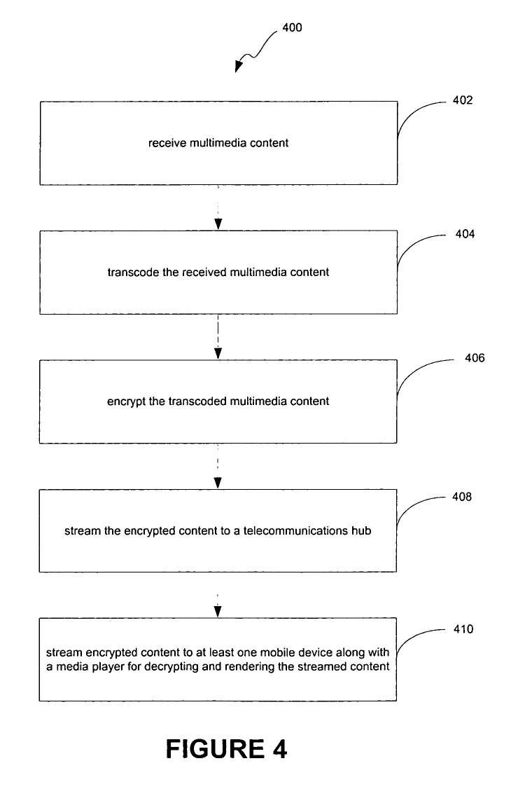

FIG. 4 illustrates another embodiment of the present invention's method to simultaneously transcode audio and video content for optimized streaming over one or more mobile telecommunications networks. In step 402, multimedia content (e.g., music, video, news, talk, traffic, etc.) is received by a transcoding server and, in step 404, the transcoding server transcodes the received multimedia content. Next, in step 406, the transcoding server encrypts the transcoded multimedia content and, in step 408, the encrypted data is forwarded to a telecommunications hub. In step 410, the telecommunications hub streams the forwarded multimedia content along with a media player to at least one mobile device over a mobile telecommunications network. In this embodiment, the media player is used to decrypt and render the encrypted multimedia content in at least one mobile device.

Additionally, the present invention provides for an article of manufacture comprising computer readable program code contained within implementing one or more modules to implement a method to simultaneously transcode audio and video content for optimized streaming over one or more mobile telecommunications networks. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

### CONCLUSION

A system and method has been shown in the above embodiments for the effective implementation of a system and method to simultaneously transcode audio and video content for optimized streaming via mobile telecommunications. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of broadcasting.

1. A method for simultaneously transcoding audio and video content for optimized streaming over one or more mobile telecommunications networks, said method comprising:
a) receiving broadcast multimedia content;
b) transcoding said received broadcast multimedia content in a format suitable for transmission over one or more telecommunication networks;
c) forwarding said transcoded multimedia content to a telecommunication hub,
d) said telecommunication hub streaming said forwarded multimedia content along with a media player to at least one mobile device over a mobile telecommunications network, and
wherein said media player used to render said streamed multimedia content in said at least one mobile device.

2. A method for simultaneously transcoding audio and video content for optimized streaming over one or more mobile telecommunications networks, as per claim 1, wherein said method further comprises the step of encrypting said transcoded content and said media player used to decrypt and render said streamed multimedia content in said at least one mobile device.

3. A method for simultaneously transcoding audio and video content for optimized streaming over one or more mobile telecommunications networks, as per claim 1, wherein said multimedia data comprises audio and video data.

4. A method for simultaneously transcoding audio and video content for optimized streaming over one or more mobile telecommunications networks, as per claim 3, wherein transcoding of said audio data is performed via a perceptual audio coder.

5. A method for simultaneously transcoding audio and video content for optimized streaming over one or more mobile telecommunications networks, as per claim 1, wherein said broadcast multimedia content is received over a satellite broadcast network.

6. A method for simultaneously transcoding audio and video content for optimized streaming over one or more mobile telecommunications networks, as per claim 1, wherein said media player is implemented as a cross-platform application.

7. A method for simultaneously transcoding audio and video content for optimized streaming over one or more mobile telecommunications networks, as per claim 1, wherein said mobile device is any of the following: cellular telephone, mobile telephone, or PDA.

8. A method for simultaneously transcoding audio and video content for optimized streaming over one or more mobile telecommunications networks, as per claim 1, wherein said cellular telephone is a Java-enabled cellular telephone.

9. A method for transcoding audio and video content for optimized streaming over one or more mobile telecommunications networks, as per claim 1, wherein said transcoded content is in MPEG4 format.

10. A method for simultaneously transcoding audio and video content for optimized streaming over one or more mobile telecommunications networks, said method comprising:
a) receiving broadcast multimedia content;
b) transcoding said received broadcast multimedia content in a format suitable for transmission over said one or more mobile telecommunications networks;
c) encrypting said transcoded multimedia content;
c) forwarding said encrypted multimedia content to a telecommunications hub, and
wherein said hub streaming said forwarded multimedia content along with a media player to at least one mobile device over a mobile telecommunications network, said media player used to decrypt and render said streamed multimedia content in said at least one mobile device.

11. A method for simultaneously transcoding audio and video content for optimized streaming over one or more mobile telecommunications networks, as per claim 10, wherein said multimedia data comprises audio and video data.

12. A method for simultaneously transcoding audio and video content for optimized streaming over one or more mobile telecommunications networks, as per claim 11, wherein transcoding of said audio data is performed via a perceptual audio coder.

13. A method for simultaneously transcoding audio and video content for optimized streaming over one or more mobile telecommunications networks, as per claim 10, wherein said multimedia content is received over a satellite broadcast network.

14. A method for simultaneously transcoding audio and video content for optimized streaming over one or more mobile telecommunications networks, as per claim 10, wherein said media player is implemented as a cross-platform application.

15. A method for simultaneously transcoding audio and video content for optimized streaming over one or more mobile telecommunications networks, as per claim 10, wherein said mobile device is any of the following: cellular telephone, mobile telephone, or PDA.

16. A method for simultaneously transcoding audio and video content for optimized streaming over one or more mobile telecommunications networks, as per claim 15, wherein said cellular telephone is a Java-enabled telephone.

17. A method for simultaneously transcoding audio and video content for optimized streaming over one or more mobile telecommunications networks, as per claim 10, wherein said transcoded content is in MPEG4 format.

18. A system to simultaneously transcode audio and video content for optimized streaming over one or more mobile telecommunications networks, said system comprising:
a) a transcoder receiving broadcast multimedia content;
b) a streamliner streaming said transcoded multimedia content to at least one telecommunication hub;
c) an application server working in conjunction with said telecommunication hub to transfer a media player along with said transcoded multimedia content to at least one mobile device over a mobile telecommunications network, said media player used to render said streamed multimedia content in said at least one mobile device.

19. A system to simultaneously transcode audio and video content for optimized streaming over one or more mobile telecommunications networks, as per claim 18, wherein said system further comprises an encrypter encrypting said transcoded multimedia content with said media player used to decrypt and render said streamed multimedia content in said at least one mobile device.

20. A system to simultaneously transcode audio and video content for optimized streaming over one or more mobile telecommunications networks, as per claim 18, wherein said multimedia data comprises audio and video data.

21. A system to simultaneously transcode audio and video content for optimized streaming over one or more mobile telecommunications networks, as per claim 18, wherein transcoding of said audio data is performed via a perceptual audio coder.

22. A system to simultaneously transcode audio and video content for optimized streaming over one or more mobile telecommunications networks, as per claim 18, wherein said multimedia content is received over a satellite broadcast network.

23. A system to simultaneously transcode audio and video content for optimized streaming over one or more mobile telecommunications networks, as per claim 18, wherein said media player is implemented as a cross-platform application.

24. A system to simultaneously transcode audio and video content for optimized streaming over one or more mobile telecommunications networks, as per claim 18, wherein said mobile device is any of the following: cellular telephone, mobile telephone, or PDA.

25. A system to simultaneously transcode audio and video content for optimized streaming over one or more mobile telecommunications networks, as per claim 24, wherein said cellular telephone is a Java-enabled telephone.

26. A system to simultaneously transcode audio and video content for optimized streaming over one or more mobile telecommunications networks, said system comprising:
a) a transcoder receiving broadcast multimedia content;
b) an encrypter encrypting said transcoded multimedia content;
c) a streamliner streaming said encoded multimedia content to at least one telecommunication hub;
d) an application server working in conjunction with said telecommunication hub to transfer a media player along with said encrypted multimedia content to at least one mobile device over a mobile telecommunications network, said media player used to decrypt and render said encrypted multimedia content in said at least one mobile device.

27. A system to simultaneously transcode audio and video content for optimized streaming over one or more mobile telecommunications networks, as per claim 26, wherein said multimedia data comprises audio and video data.

28. A system to simultaneously transcode audio and video content for optimized streaming over one or more mobile telecommunications networks, as per claim 27, wherein transcoding of said audio data is performed via a perceptual audio coder.

29. A system to simultaneously transcode audio and video content for optimized streaming over one or more mobile telecommunications networks, as per claim 26, wherein said multimedia content is received over a satellite broadcast network.

30. A system to simultaneously transcode audio and video content for optimized streaming over one or more mobile telecommunications networks, as per claim 26, wherein said media player is implemented as a cross-platform application.

31. A system to simultaneously transcode audio and video content for optimized streaming over one or more mobile telecommunications networks, as per claim 26, wherein said mobile device is any of the following: cellular telephone, mobile telephone, or PDA.

32. A system to simultaneously transcode audio and video content for optimized streaming over one or more mobile telecommunications networks, as per claim 31, wherein said cellular telephone is a Java-enabled telephone.

33. A system to simultaneously transcode audio and video content for optimized streaming over one or more mobile telecommunications networks, as per claim 26, wherein said transcoded content is in a MPEG4 format.
